(19) United States
(12) Patent Application Publication
(10) Pub. No.: US 2019/0003240 A1
(43) Pub. Date: Jan. 3, 2019

(54) GARAGE DOOR CONTROLLER

(71) Applicants: Brian Hoang, Renton, WA (US); Matthew Lam, Cedar Park, TX (US); Diem To, Renton, WA (US); Thai Nguyen, Tukwila, WA (US); Duc Tran, Seattle, WA (US); Ky The To, Renton, WA (US)

(72) Inventors: Brian Hoang, Renton, WA (US); Matthew Lam, Cedar Park, TX (US); Diem To, Renton, WA (US); Thai Nguyen, Tukwila, WA (US); Duc Tran, Seattle, WA (US); Ky The To, Renton, WA (US)

(21) Appl. No.: 15/785,026

(22) Filed: Oct. 16, 2017

Related U.S. Application Data
(60) Provisional application No. 62/526,915, filed on Jun. 29, 2017.

(51) Int. Cl. E05F 15/76; E05F 15/77

(52) U.S. Cl. CPC E05F 15/76; E05F 2015/763; E05F 15/77

(57) ABSTRACT

This invention relates generally to a garage door control system. A system includes, but is not limited to: sensor devices that detect a position of a garage door from a floor using a distance from the devices and the door, the devices being mounted at a far end of a horizontal guidance track; a control unit coupled to the sensor devices, the control unit including at least a computer processor; a power distribution and control relay unit; a wireless communication interface operable to communicate wirelessly; and a link connected to the garage door motor; and a user interface unit in place of the existing garage door button, wherein the user interface receives power from the power distribution and control relay unit via wires repurposed from control signal wires of the existing garage door button, the user interface including: a wireless communication interface to communicate wirelessly; and a display screen.

### PRIORITY CLAIM

This application claims priority from U.S. provisional patent application 62/526,915 filed on Jun. 29, 2017.

This application claims the benefit of and/or priority of the foregoing patent application and any and all parent, grandparent, and great-grandparent applications thereof. The foregoing patent application is incorporated by reference in its entirety as if fully set forth herein.

### FIELD OF THE INVENTION

This invention relates generally to a garage door opening system.

### SUMMARY

This invention relates generally to a garage door control system. In one embodiment, a system is comprised of: one or more sensor devices that are configured to detect a position of a garage door from a floor indirectly using a distance from the one or more sensor devices and the garage door down a horizontal guidance track, the one or more sensor devices configured to be mounted at a far end of the horizontal guidance track of the garage door, the one or more sensor devices including: one or more emitters, one or more detectors; a control unit configured to be mounted proximate a garage door motor for the garage door and coupled to the one or more sensor devices, the control unit including at least: a computer processor configured to provide the enhanced functionality; a power distribution and control relay unit; a first wireless communication interface operable to communicate wirelessly; and a link operable to be connected to the garage door motor; and a user interface unit locatable in place of the existing garage door button, wherein the user interface is configured to receive power from the power distribution and control relay unit via wires repurposed from control signal wires of the existing garage door button, the user interface including: a second wireless communication interface operable to communicate wirelessly with the first wireless communication interface of the control unit to enable control of the enhanced functionality; and a display screen.

### BRIEF DESCRIPTION OF THE DRAWINGS

Embodiments of the present invention are described in detail below with reference to the following drawings.

FIG. 1 is a is a perspective view of a garage door control system, in accordance with an embodiment of the invention;

FIG. 2 is an isometric perspective of a sensor device, in accordance with an embodiment of the invention;

FIG. 3 is an isometric perspective of a sensor device, in accordance with an embodiment of the invention;

FIG. 4 is a front perspective of a sensor device, in accordance with an embodiment of the invention;

FIG. 5 is a rear perspective of a sensor device, in accordance with an embodiment of the invention;

FIG. 6 is an isometric perspective of a control unit, in accordance with an embodiment of the invention;

FIG. 7 is an isometric perspective of a control unit, in accordance with an embodiment of the invention;

FIG. 8 is a front perspective of a control unit, in accordance with an embodiment of the invention;

FIG. 9 is a rear perspective of a control unit, in accordance with an embodiment of the invention;

FIG. 10 is an isometric perspective of a power distribution and control relay unit, in accordance with an embodiment of the invention;

FIG. 11 is an isometric perspective of a power distribution and control relay unit, in accordance with an embodiment of the invention;

FIG. 12 is a front perspective of a power distribution and control relay unit, in accordance with an embodiment of the invention;

FIG. 13 is a rear perspective of a power distribution and control relay unit, in accordance with an embodiment of the invention; and

FIG. 14 is a block diagram of the method used to install the enhanced garage door control system, in accordance with an embodiment of the invention.

### DETAILED DESCRIPTION

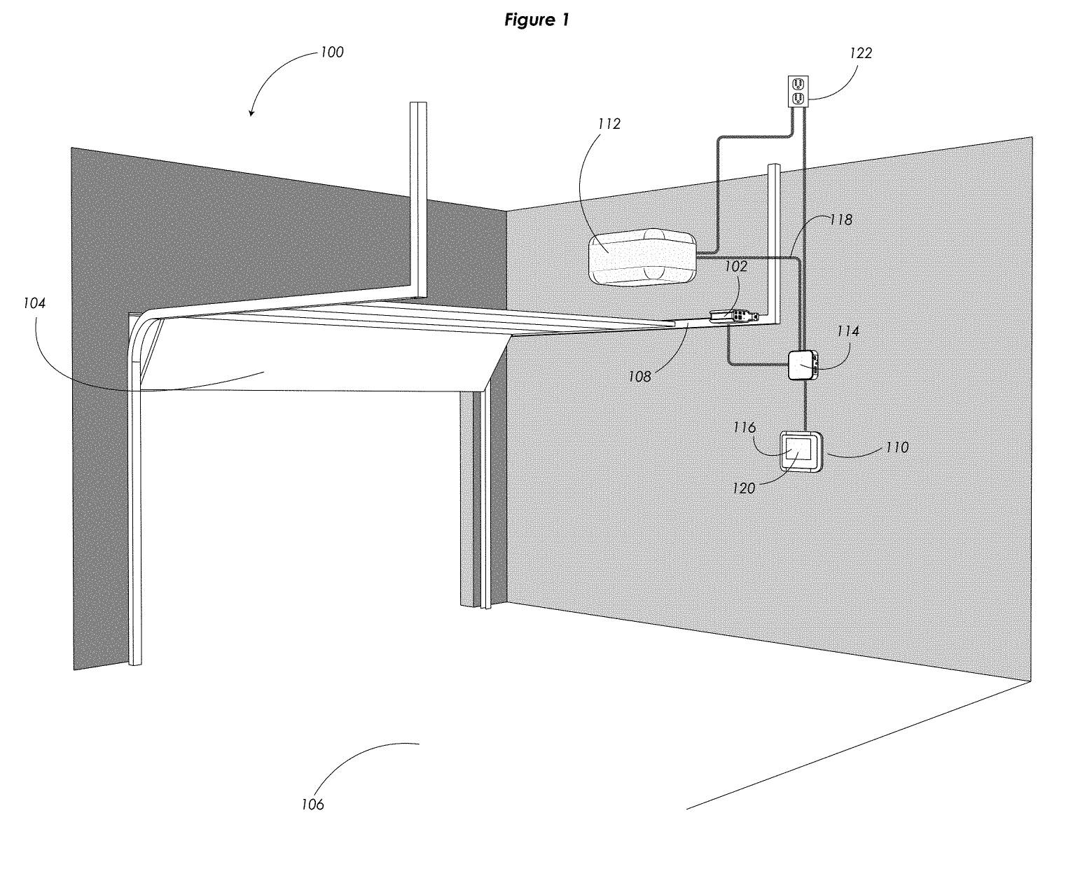

This invention relates generally to a garage door control system. Certain embodiments of the invention are set forth in the following description and in FIGS. 1-14 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a perspective view of a garage door control system 100. In one embodiment, a system 100 is comprised of: one or more sensor devices 102 that are configured to detect a position of a garage door 104 from a floor 106 indirectly using a distance from the one or more sensor devices 102 and the garage door 104 down a horizontal guidance track 108, the one or more sensor devices 102 configured to be mounted at a far end of the horizontal guidance track 108 of the garage door 104, the one or more sensor devices 102 including: one or more emitters, one or more detectors; a control unit 110 configured to be mounted proximate a garage door motor 112 for the garage door 104 and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires 118 repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug 122 and distribute the power, and wherein the power distribution and control relay unit 114 is configured to be linked to a garage door motor 112 for a garage door 104; one or more sensor devices 102, that detect a position of the garage door 104 from a floor indirectly using a distance from the one or more sensor devices 102 and the garage door 104 down a horizontal guidance track 108, the one or more sensor devices 102 configured to be mounted at a far end of the horizontal guidance track 108 of the garage door 104, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door 104 button, wherein the control unit 110 is configured to receive power from the power distribution and control relay unit 114 via control signal wires of the existing garage door 104 button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the power distribution and control relay unit 114 ranges in dimensions from 1 inch×1 inch×1 inch to 10 inches×10 inches×10 inches. The power distribution and control relay unit 114 may have one or more external ports through which it may connect to or be connected to sources of power or other wires. The power distribution and control relay unit 114 may have an integrated DC or AC wire connector, and ports to connect an existing garage door control wire. The power distribution and control relay unit 114 may have a mechanism to attach to a garage door motor 112 or other surface which may be characterized as, but not limited to, a magnetized strip, adhesives, a latch, a locking mechanism, an integrated screw or screws, channels for other fasteners, or some combination of the aforementioned or other fastening mechanisms.

In some embodiments, the one or more sensor devices 102 are a combination of ultrasonic emitter and detector capable of emitting and detecting ultrasonic waves respectively. The one or more sensor devices 102 are capable of processing the detected and emitted waves to determine the distance from the one or more sensor devices 102 to an object in the path of the emitted ultrasonic waves. In some embodiments, the one or more sensor devices 102 are placed in the guide rail of a garage door system at the far end of the guide rail system to be able to detect when a garage door is raised and/or lowered, and at what position the garage door is at during some or all of its traversal of its path.

In some embodiments the one or more sensor devices 102 range in size from 0.5 inches wide×0.5 inches tall×0.5 inches deep to 12 inches wide×12 inches tall×12 inches deep. The size of the one or more sensor devices 102 can vary to sufficiently fit a guide rail of a garage door motor 112 system. In some embodiments the sensor is of a regular polyhedron with six sides. In some embodiments the one or more sensor devices 102 are of a different polyhedral shape. In some embodiments the one or more sensor devices 102 have openings on one face for emitters and detectors, and a port for power on another side. In some embodiments the openings and port are on the same side. In some embodiments the port for power is an ethernet port, but in other embodiments it is a port for a DC or AC current, or may be omitted in place of a battery power source. In some embodiments the emitter and detector openings are circular, but can be characterized by any shape including but not limited to a line, circle, square, triangle, pentagon, or hexagon. In some embodiments the one or more sensor devices 102 is further comprised of one or more speakers able to emit one or more noises, or a variety of noises.

In some embodiments, the one or more sensor devices 102 have one or more fastening mechanisms to attach them to a garage door guide rail or other location. In some embodiments these fastening mechanisms are channels through which a screw may pass, while in other embodiments the fastening mechanisms may be characterized by, but are not limited to, magnetized strips or panels, latches, graspers, clamps, or adhesives.

In some embodiments, the one or more sensor devices 102 is comprised of a light emitter and light detector, such as, but not limited to, a laser, and utilizes it to detect the distance a garage door is from the one or more sensor devices 102. The one or more sensor devices 102 can be of a variety of types including but not limited to ultrasonic, radar, or laser. The one or more sensor devices 102 may instead be comprised of two separate devices, an emitter and a detector. The one or more sensor devices 102 may be further comprised of relays or other devices capable of reflecting the emitted waves to allow the detector to detect distances around corners or at angles.

In some embodiments, the one or more sensor devices 102 have a wireless communication interface located inside of the devices though they may have an antenna or other communication facilitation device emerging from them or located on their outer surface. The wireless communication interface is operable to communicate wirelessly with other devices including a control unit 110, power distribution and control relay unit 114, user interface 116, or a control unit 110.

In some embodiments, the system further comprises additional sensor devices, each with an additional third wireless communication interface operable to communicate with the second wireless communication interface of the control unit 110 to enable control of the enhanced functionality of other garage door motors 112 without any additional wires.

In some embodiments the control unit 110 is configured to provide instructions to additional sensor devices beyond the first and is configured to distinguish between the additional sensor devices. In some embodiments the control unit 110 is configured to interpret sensor data from additional sensor units and provide instructions to control one or more additional garage door motors 112.

In some embodiments, a system includes a control unit 110 that is locatable in place of an existing garage door button control, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 has dimensions ranging from 1 inch wide×1 inch tall×1 inch deep to 18 inches wide×18 inches tall×18 inches deep depending on the needs and configuration of the embodiment. In some embodiments the control unit 110 is characterized by a square polyhedron shape, but it can be characterized as other polyhedrons with four or more sides.

In some embodiments, the control unit 110 has a user interface 116 including a display screen 120. In some embodiments, the user interface 116 may be characterized by a variety of different variants including, but not limited to, a touchscreen, a digital display screen 120, an analog display screen 120 one or more buttons, one or more dials, or a combination of the foregoing or other variants. The user interface 116 may vary in size between be 1 inch wide×1 inch tall and 18 inches wide×18 inches tall.

In some embodiments, the control unit 110 comprises a second wireless communication interface operable to communicate wirelessly with the first wireless communication interface of the one or more sensor devices 102, and any other communication interfaces as needed. The second wireless communication interface may be entirely contained within the control unit 110 or it may have external antennae or other components beyond a housing. In some embodiments the second wireless communication interface may be configured to communicate with a home or business local area network through a direct wire connection or wirelessly. In some embodiments the second wireless communication interface receives data from a home or business local area network, while in others it receives it directly from a user's device.

In some embodiments the control unit 110 is further comprised of a computer processor which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 further comprises circuitry configured for receiving data about the current, past, or possible future location of a user from one or more wireless user devices such as a smart phone, GPS device, or other location-tracking device. This data can be received through the first wireless device through communication with an internal network or directly from another device. In some embodiments the control unit 110 is further comprised of circuitry configured to instruct the power distribution and control relay unit 114 to open or close a garage door based on user location data provided by one or more wireless user devices, depending on a variety of parameters set into the control unit 110's computer processor. Such parameters include, but are not limited to, a geographic region that when entered or exited triggers opening or closing of the garage door respectively, reaching a certain point on a pre-programmed route triggers opening or closing of the garage door respectively, time of day, day of the week, month of the year, and the year.

In some embodiments, the control unit 110 further comprises circuitry for interfacing with one or more voice control devices, such as, but not limited to, Amazon's Alexa or Apple's Siri. In some embodiments, the control unit 110 further comprises circuitry for interfacing with one or more voice control devices that may be integrated and/or to the control unit 110 itself and provide commands to the power distribution and control relay unit 114 based on words spoken by a user to the voice control device.

In some embodiments the control unit 110 further comprises circuitry configured to transmit data on the position of the garage door to one or more users. In some embodiments, this circuitry is able to send the data using the second wireless communication interface to a home or business local area network, while in other embodiments the circuitry is able to instruct the second wireless communication interface to send the data on the position of one or more garage doors directly to one or more user device such as a smartphone or handheld device.

In some embodiments the control unit 110 further comprises circuitry configured to notify one or more users when the garage door is opened. The control unit 110's circuitry may send an alert to an application specifically designed to interface with the second wireless communication interface, or may a message such as, but not limited to, a text or other form of message may be sent to one or more users to alert them of the opening or closing of one or more garage doors.

In some embodiments the control unit 110 further comprises circuitry configured to allow one or more users to provide one or more commands to the control unit 110 remotely through one or more devices. The commands may include the command to open or close one or more garage doors, modifying settings or parameters used by the control unit 110 or its computer processor such as, but not limited to, specifying a time for one or more garage doors to open, having the display screen 120 display a message to one or more users, or modifying the range at which the garage door will open for an approaching user.

In some embodiments, the control unit 110 is configured to use the second wireless communications interface to interface with additional sensor devices beyond the first and to control additional garage door motors 112 coupled to the two or more sensor devices. A singular control unit 110 can in turn control numerous garage door motors 112, and enable users to control all of the garage doors, through its interface with the multiple sensor units.

In some embodiments, the user interface 116 is configured to provide a selectable option, receive a selection, and produce an output on the display screen 120 based on the selection. This selection may include, but is not limited to pre-assigned messages to other users, the user may input their own message to be displayed to other users, or the user may modify the parameters upon which the control unit 110 will instruct the power distribution and relay control unit 110 to operate the garage door motor 112.

In some embodiments the user interface 116 further comprises a timer; and circuitry configured to interpret time data from the timer and send one or more instructions to the control unit 110. The one or more instructions may be, but are not limited to, instructions to open or close the one or more garage doors at a specific time, or to ensure that the one or more garage doors are closed and remain closed after a certain time.

In some embodiments the system further comprises: a sound detector coupled to the user interface 116 unit; and circuitry configured for interpreting sound data detected by the sound detector. The sound detector may be coupled to the control unit 110, or may be located inside of the control unit 110. The sound detector data may include audio commands provided by one or more users.

In some embodiments, the user interface 116 further comprises circuitry configured for communicating wirelessly with one or more mobile devices. This circuitry may allow a user of the user interface 116 to provide messages or other information to one or more other users through the garage door control unit 110. The information may be in the form of textual notices, sound or visual notifications, or other means of alerting one or more users.

In some embodiments, the user interface 116 further comprises circuitry configured for creating a recording of changes in the position of the one or more garage doors and storing the recording of changes in the position of the one or more garage doors electronically. The record may include, but is not limited to, the date and time of the opening or closing of a garage door, which one or more users provided the command to open, which device or means was used to provide the instruction to open, and/or where the expected users were located at the time of the opening. In some embodiments, the user interface 116 is configured to use the second wireless communication interface to upload the data to a cloud server, one or more user devices, an on-site server, or other storage medium.

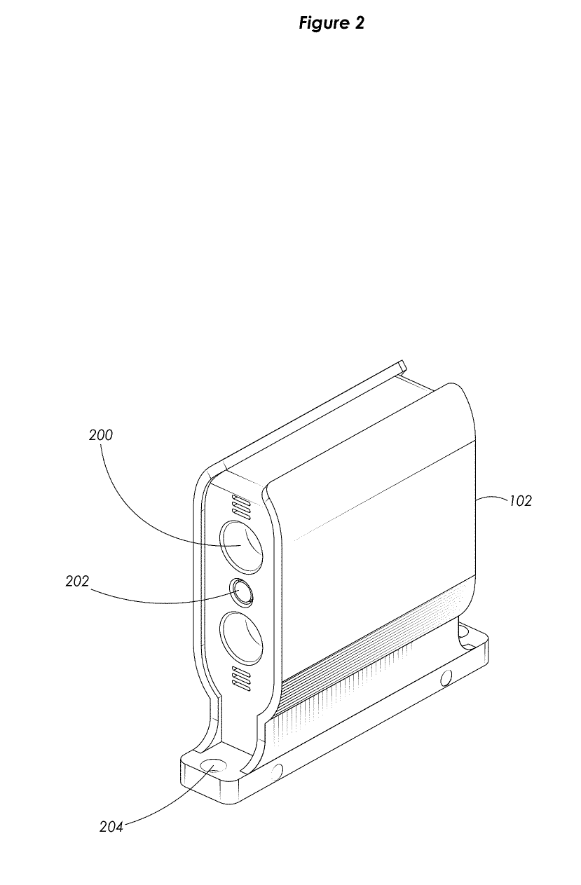

FIG. 2 is an isometric perspective of a sensor device in accordance with an embodiment of the invention. In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters 200, one or more detectors 202; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door; one or more sensor devices 102, that detect a position of the garage door from a floor indirectly using a distance from the one or more sensor devices 102 and the garage door down a horizontal guidance track 108, the one or more sensor devices 102 configured to be mounted at a far end of the horizontal guidance track 108 of the garage door, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the one or more sensor devices 102 are a combination of ultrasonic emitter and detector capable of emitting and detecting ultrasonic waves respectively. The one or more sensor devices 102 are capable of processing the detected and emitted waves to determine the distance from the one or more sensor devices 102 to an object in the path of the emitted ultrasonic waves. In some embodiments, the one or more sensor devices 102 are placed in the guide rail of a garage door system at the far end of the guide rail system to be able to detect when a garage door is raised and/or lowered, and at what position the garage door is at during some or all of its traversal of its path.

In some embodiments the one or more sensor devices 102 range in size from 0.5 inches wide by 0.5 inches tall by 0.5 inches deep to 12 inches wide by 12 inches tall by 12 inches deep. The size of the one or more sensor devices 102 can vary to sufficiently fit a guide rail of a garage door motor 112 system. In some embodiments the sensor is of a regular polyhedron with six sides. In some embodiments the one or more sensor devices 102 are of a different polyhedral shape. In some embodiments the one or more sensor devices 102 have openings on one face for emitters 200 and detectors 202, and a port for power on another side. In some embodiments the openings and port are on the same side. In some embodiments the port for power is an ethernet port, but in other embodiments it is a port for a DC or AC current, or may be omitted in place of a battery power source. In some embodiments the emitter and detector openings are circular, but can be characterized by any shape including but not limited to a line, circle, square, triangle, pentagon, or hexagon. In some embodiments the one or more sensor devices 102 is further comprised of one or more speakers able to emit one or more noises, or a variety of noises.

In some embodiments, the one or more sensor devices 102 have one or more fastening mechanisms 204 to attach them to a garage door guide rail or other location. In some embodiments these fastening mechanisms are channels through which a screw may pass, while in other embodiments the fastening mechanisms may be characterized by, but are not limited to, magnetized strips or panels, latches, graspers, clamps, or adhesives.

In some embodiments, the one or more sensor devices 102 is comprised of a light emitter and light detector, such as, but not limited to, a laser, and utilizes it to detect the distance a garage door is from the one or more sensor devices 102. The one or more sensor devices 102 can be of a variety of types including but not limited to ultrasonic, radar, or laser. The one or more sensor devices 102 may instead be comprised of two separate devices, an emitter and a detector. The one or more sensor devices 102 may be further comprised of relays or other devices capable of reflecting the emitted waves to allow the detector to detect distances around corners or at angles.

In some embodiments, the one or more sensor devices 102 have a wireless communication interface located inside of the devices though they may have an antenna or other communication facilitation device emerging from them or located on their outer surface. The wireless communication interface is operable to communicate wirelessly with other devices including a control unit 110, power distribution and control relay unit 114, user interface 116, or a control unit 110.

In some embodiments, the system further comprises additional sensor devices, each with an additional third wireless communication interface operable to communicate with the second wireless communication interface of the control unit 110 to enable control of the enhanced functionality of other garage door motors 112 without any additional wires.

In some embodiments the control unit 110 is configured to provide instructions to additional sensor devices beyond the first and is configured to distinguish between the additional sensor devices. In some embodiments the control unit 110 is configured to interpret sensor data from additional sensor units and provide instructions to control one or more additional garage door motors 112.

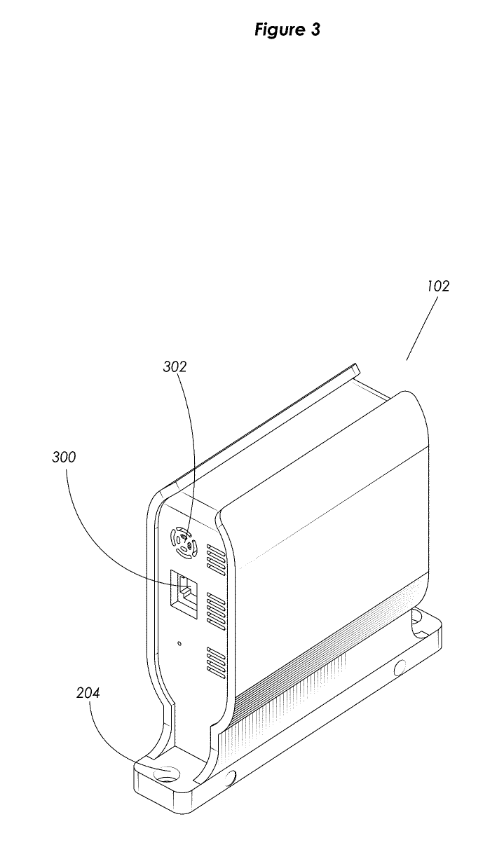

FIG. 3 is an isometric perspective of a sensor device in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door; one or more sensor devices 102, that detect a position of the garage door from a floor indirectly using a distance from the one or more sensor devices 102 and the garage door down a horizontal guidance track 108, the one or more sensor devices 102 configured to be mounted at a far end of the horizontal guidance track 108 of the garage door, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the one or more sensor devices 102 are a combination of ultrasonic emitter and detector capable of emitting and detecting ultrasonic waves respectively. The one or more sensor devices 102 are capable of processing the detected and emitted waves to determine the distance from the one or more sensor devices 102 to an object in the path of the emitted ultrasonic waves. In some embodiments, the one or more sensor devices 102 are placed in the guide rail of a garage door system at the far end of the guide rail system to be able to detect when a garage door is raised and/or lowered, and at what position the garage door is at during some or all of its traversal of its path.

In some embodiments the one or more sensor devices 102 range in size from 0.5 inches wide×0.5 inches tall×0.5 inches deep to 12 inches wide×12 inches tall×12 inches deep. The size of the one or more sensor devices 102 can vary to sufficiently fit a guide rail of a garage door motor 112 system. In some embodiments the sensor is of a regular polyhedron with six sides. In some embodiments the one or more sensor devices 102 are of a different polyhedral shape. In some embodiments the one or more sensor devices 102 have openings on one face for emitters and detectors, and a port for power on another side. In some embodiments the openings and port are on the same side. In some embodiments the port for power is an ethernet port 300, but in other embodiments it is a port for a DC or AC current, or may be omitted in place of a battery power source. In some embodiments the emitter and detector openings are circular, but can be characterized by any shape including but not limited to a line, circle, square, triangle, pentagon, or hexagon. In some embodiments the one or more sensor devices 102 is further comprised of one or more speakers 302 able to emit one or more noises, or a variety of noises.

In some embodiments, the one or more sensor devices 102 have one or more fastening mechanisms 204 to attach them to a garage door guide rail or other location. In some embodiments these fastening mechanisms are channels through which a screw may pass, while in other embodiments the fastening mechanisms may be characterized by, but are not limited to, magnetized strips or panels, latches, graspers, clamps, or adhesives.

In some embodiments, the one or more sensor devices 102 is comprised of a light emitter and light detector, such as, but not limited to, a laser, and utilizes it to detect the distance a garage door is from the one or more sensor devices 102. The one or more sensor devices 102 can be of a variety of types including but not limited to ultrasonic, radar, or laser. The one or more sensor devices 102 may instead be comprised of two separate devices, an emitter and a detector. The one or more sensor devices 102 may be further comprised of relays or other devices capable of reflecting the emitted waves to allow the detector to detect distances around corners or at angles.

In some embodiments, the one or more sensor devices 102 have a wireless communication interface located inside of the devices though they may have an antenna or other communication facilitation device emerging from them or located on their outer surface. The wireless communication interface is operable to communicate wirelessly with other devices including a control unit 110, power distribution and control relay unit 114, user interface 116, or a control unit 110.

In some embodiments, the system further comprises additional sensor devices, each with an additional third wireless communication interface operable to communicate with the second wireless communication interface of the control unit 110 to enable control of the enhanced functionality of other garage door motors 112 without any additional wires.

In some embodiments the control unit 110 is configured to provide instructions to additional sensor devices beyond the first and is configured to distinguish between the additional sensor devices. In some embodiments the control unit 110 is configured to interpret sensor data from additional sensor units and provide instructions to control one or more additional garage door motors 112.

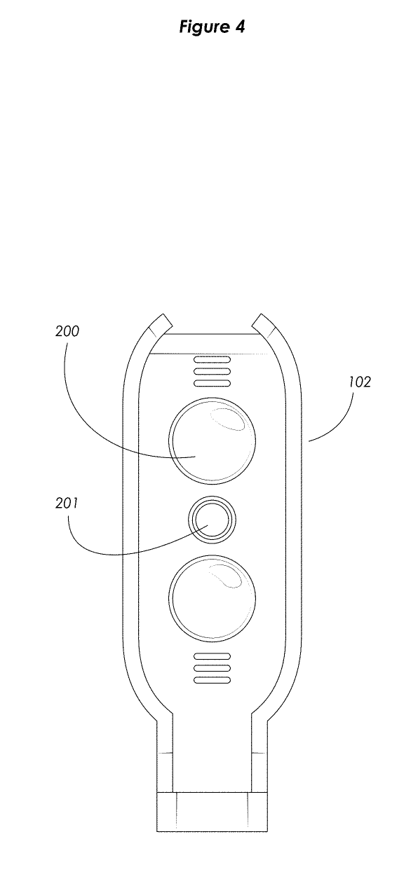

FIG. 4 is a front perspective of a sensor device in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters 200, one or more detectors 202; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door; one or more sensor devices 102, that detect a position of the garage door from a floor indirectly using a distance from the one or more sensor devices 102 and the garage door down a horizontal guidance track 108, the one or more sensor devices 102 configured to be mounted at a far end of the horizontal guidance track 108 of the garage door, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the one or more sensor devices 102 are a combination of ultrasonic emitter and detector capable of emitting and detecting ultrasonic waves respectively. The one or more sensor devices 102 are capable of processing the detected and emitted waves to determine the distance from the one or more sensor devices 102 to an object in the path of the emitted ultrasonic waves. In some embodiments, the one or more sensor devices 102 are placed in the guide rail of a garage door system at the far end of the guide rail system to be able to detect when a garage door is raised and/or lowered, and at what position the garage door is at during some or all of its traversal of its path.

In some embodiments the one or more sensor devices 102 range in size from 0.5 inches wide by 0.5 inches tall by 0.5 inches deep to 12 inches wide by 12 inches tall by 12 inches deep. The size of the one or more sensor devices 102 can vary to sufficiently fit a guide rail of a garage door motor 112 system. In some embodiments the sensor is of a regular polyhedron with six sides. In some embodiments the one or more sensor devices 102 are of a different polyhedral shape. In some embodiments the one or more sensor devices 102 have openings on one face for emitters 200 and detectors 202, and a port for power on another side. In some embodiments the openings and port are on the same side. In some embodiments the port for power is an ethernet port, but in other embodiments it is a port for a DC or AC current, or may be omitted in place of a battery power source. In some embodiments the emitter and detector openings are circular, but can be characterized by any shape including but not limited to a line, circle, square, triangle, pentagon, or hexagon. In some embodiments the one or more sensor devices 102 is further comprised of one or more speakers able to emit one or more noises, or a variety of noises.

In some embodiments, the one or more sensor devices 102 have one or more fastening mechanisms to attach them to a garage door guide rail or other location. In some embodiments these fastening mechanisms are channels through which a screw may pass, while in other embodiments the fastening mechanisms may be characterized by, but are not limited to, magnetized strips or panels, latches, graspers, clamps, or adhesives.

In some embodiments, the one or more sensor devices 102 is comprised of a light emitter and light detector, such as, but not limited to, a laser, and utilizes it to detect the distance a garage door is from the one or more sensor devices 102. The one or more sensor devices 102 can be of a variety of types including but not limited to ultrasonic, radar, or laser. The one or more sensor devices 102 may instead be comprised of two separate devices, an emitter and a detector. The one or more sensor devices 102 may be further comprised of relays or other devices capable of reflecting the emitted waves to allow the detector to detect distances around corners or at angles.

In some embodiments, the one or more sensor devices 102 have a wireless communication interface located inside of the devices though they may have an antenna or other communication facilitation device emerging from them or located on their outer surface. The wireless communication interface is operable to communicate wirelessly with other devices including a control unit 110, power distribution and control relay unit 114, user interface 116, or a control unit 110.

In some embodiments, the system further comprises additional sensor devices, each with an additional third wireless communication interface operable to communicate with the second wireless communication interface of the control unit 110 to enable control of the enhanced functionality of other garage door motors 112 without any additional wires.

In some embodiments the control unit 110 is configured to provide instructions to additional sensor devices beyond the first and is configured to distinguish between the additional sensor devices. In some embodiments the control unit 110 is configured to interpret sensor data from additional sensor units and provide instructions to control one or more additional garage door motors 112.

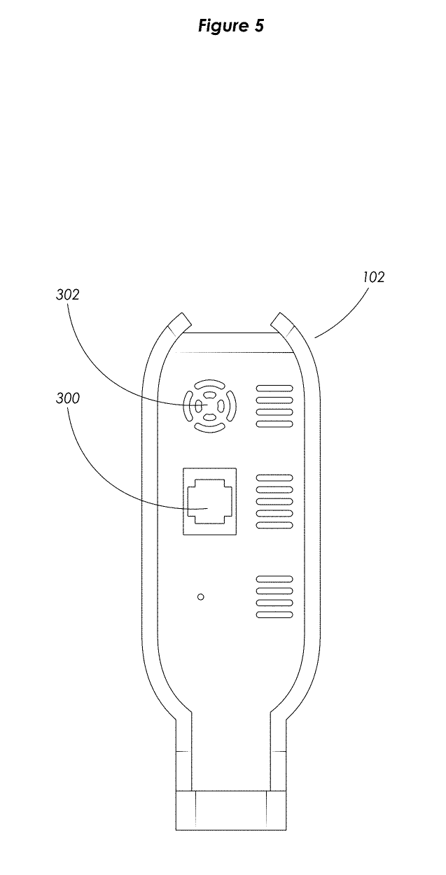

FIG. 5 is a rear perspective of a sensor device in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door; one or more sensor devices 102, that detect a position of the garage door from a floor indirectly using a distance from the one or more sensor devices 102 and the garage door down a horizontal guidance track 108, the one or more sensor devices 102 configured to be mounted at a far end of the horizontal guidance track 108 of the garage door, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the one or more sensor devices 102 are a combination of ultrasonic emitter and detector capable of emitting and detecting ultrasonic waves respectively. The one or more sensor devices 102 are capable of processing the detected and emitted waves to determine the distance from the one or more sensor devices 102 to an object in the path of the emitted ultrasonic waves. In some embodiments, the one or more sensor devices 102 are placed in the guide rail of a garage door system at the far end of the guide rail system to be able to detect when a garage door is raised and/or lowered, and at what position the garage door is at during some or all of its traversal of its path.

In some embodiments the one or more sensor devices 102 range in size from 0.5 inches wide×0.5 inches tall×0.5 inches deep to 12 inches wide×12 inches tall×12 inches deep. The size of the one or more sensor devices 102 can vary to sufficiently fit a guide rail of a garage door motor 112 system. In some embodiments the sensor is of a regular polyhedron with six sides. In some embodiments the one or more sensor devices 102 are of a different polyhedral shape. In some embodiments the one or more sensor devices 102 have openings on one face for emitters and detectors, and a port for power on another side. In some embodiments the openings and port are on the same side. In some embodiments the port for power is an ethernet port 300, but in other embodiments it is a port for a DC or AC current, or may be omitted in place of a battery power source. In some embodiments the emitter and detector openings are circular, but can be characterized by any shape including but not limited to a line, circle, square, triangle, pentagon, or hexagon. In some embodiments the one or more sensor devices 102 is further comprised of one or more speakers 302 able to emit one or more noises, or a variety of noises.

In some embodiments, the one or more sensor devices 102 have one or more fastening mechanisms to attach them to a garage door guide rail or other location. In some embodiments these fastening mechanisms are channels through which a screw may pass, while in other embodiments the fastening mechanisms may be characterized by, but are not limited to, magnetized strips or panels, latches, graspers, clamps, or adhesives.

In some embodiments, the one or more sensor devices 102 is comprised of a light emitter and light detector, such as, but not limited to, a laser, and utilizes it to detect the distance a garage door is from the one or more sensor devices 102. The one or more sensor devices 102 can be of a variety of types including but not limited to ultrasonic, radar, or laser. The one or more sensor devices 102 may instead be comprised of two separate devices, an emitter and a detector. The one or more sensor devices 102 may be further comprised of relays or other devices capable of reflecting the emitted waves to allow the detector to detect distances around corners or at angles.

In some embodiments, the one or more sensor devices 102 have a wireless communication interface located inside of the devices though they may have an antenna or other communication facilitation device emerging from them or located on their outer surface. The wireless communication interface is operable to communicate wirelessly with other devices including a control unit 110, power distribution and control relay unit 114, user interface 116, or a control unit 110.

In some embodiments, the system further comprises additional sensor devices, each with an additional third wireless communication interface operable to communicate with the second wireless communication interface of the control unit 110 to enable control of the enhanced functionality of other garage door motors 112 without any additional wires.

In some embodiments the control unit 110 is configured to provide instructions to additional sensor devices beyond the first and is configured to distinguish between the additional sensor devices. In some embodiments the control unit 110 is configured to interpret sensor data from additional sensor units and provide instructions to control one or more additional garage door motors 112.

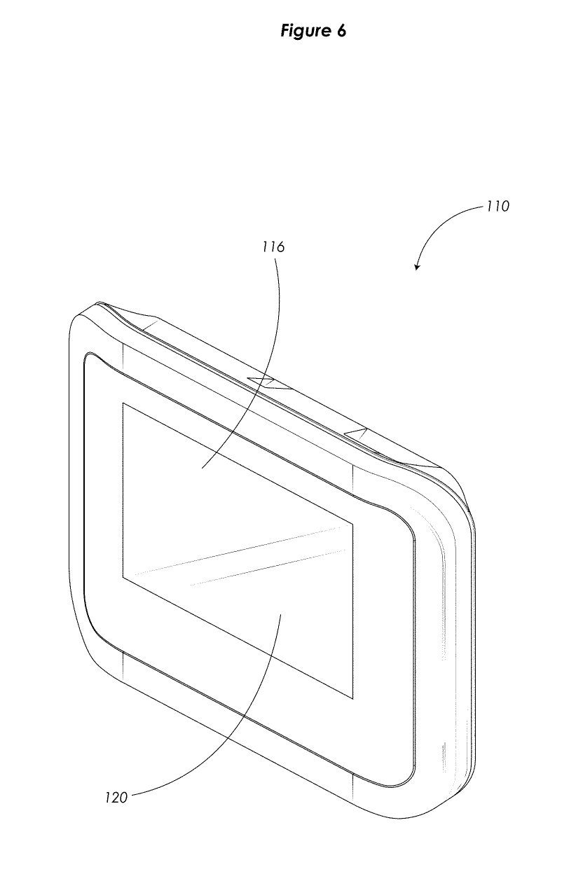

FIG. 6 is an isometric perspective of a control unit in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door 104; one or more sensor devices 102, that detect a position of the garage door 104 from a floor indirectly using a distance from the one or more sensor devices 102 and the garage door 104 down a horizontal guidance track 108, the one or more sensor devices 102 configured to be mounted at a far end of the horizontal guidance track 108 of the garage door 104, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, a system includes a control unit 110 that is locatable in place of an existing garage door button control, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 has dimensions ranging from 1 inch wide×1 inch tall×1 inch deep to 18 inches wide×18 inches tall×18 inches deep depending on the needs and configuration of the embodiment. In some embodiments the control unit 110 is characterized by a square polyhedron shape, but it can be characterized as other polyhedrons with four or more sides.

In some embodiments, the control unit 110 has a user interface 116 including a display screen 120. In some embodiments, the user interface 116 may be characterized by a variety of different variants including, but not limited to, a touchscreen, a digital display screen 120, an analog display screen 120 one or more buttons, one or more dials, or a combination of the foregoing or other variants. The user interface 116 may vary in size between be 1 inch wide×1 inch tall and 18 inches wide×18 inches tall.

In some embodiments, the control unit 110 comprises a second wireless communication interface operable to communicate wirelessly with the first wireless communication interface of the one or more sensor devices 102, and any other communication interfaces as needed. The second wireless communication interface may be entirely contained within the control unit 110 or it may have external antennae or other components beyond a housing. In some embodiments the second wireless communication interface may be configured to communicate with a home or business local area network through a direct wire connection or wirelessly. In some embodiments the second wireless communication interface receives data from a home or business local area network, while in others it receives it directly from a user's device.

In some embodiments the control unit 110 is further comprised of a computer processor which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 further comprises circuitry configured for receiving data about the current, past, or possible future location of a user from one or more wireless user devices such as a smart phone, GPS device, or other location-tracking device. This data can be received through the first wireless device through communication with an internal network or directly from another device. In some embodiments the control unit 110 is further comprised of circuitry configured to instruct the power distribution and control relay unit 114 to open or close a garage door 104 based on user location data provided by one or more wireless user devices, depending on a variety of parameters set into the control unit 110's computer processor. Such parameters include, but are not limited to, a geographic region that when entered or exited triggers opening or closing of the garage door 104 respectively, reaching a certain point on a pre-programmed route triggers opening or closing of the garage door 104 respectively, time of day, day of the week, month of the year, and the year.

In some embodiments, the control unit 110 further comprises circuitry for interfacing with one or more voice control devices, such as, but not limited to, Amazon's Alexa or Apple's Siri. In some embodiments, the control unit 110 further comprises circuitry for interfacing with one or more voice control devices that may be integrated and/or to the control unit 110 itself and provide commands to the power distribution and control relay unit 114 based on words spoken by a user to the voice control device.

In some embodiments the control unit 110 further comprises circuitry configured to transmit data on the position of the garage door 104 to one or more users. In some embodiments, this circuitry is able to send the data using the second wireless communication interface to a home or business local area network, while in other embodiments the circuitry is able to instruct the second wireless communication interface to send the data on the position of one or more garage doors 104 directly to one or more user device such as a smartphone or handheld device.

In some embodiments the control unit 110 further comprises circuitry configured to notify one or more users when the garage door 104 is opened. The control unit 110's circuitry may send an alert to an application specifically designed to interface with the second wireless communication interface, or may a message such as, but not limited to, a text or other form of message may be sent to one or more users to alert them of the opening or closing of one or more garage doors 104.

In some embodiments the control unit 110 further comprises circuitry configured to allow one or more users to provide one or more commands to the control unit 110 remotely through one or more devices. The commands may include the command to open or close one or more garage doors 104, modifying settings or parameters used by the control unit 110 or its computer processor such as, but not limited to, specifying a time for one or more garage doors 104 to open, having the display screen 120 display a message to one or more users, or modifying the range at which the garage door 104 will open for an approaching user.

In some embodiments, the control unit 110 is configured to use the second wireless communications interface to interface with additional sensor devices beyond the first and to control additional garage door motors 112 coupled to the two or more sensor devices. A singular control unit 110 can in turn control numerous garage door motors 112, and enable users to control all of the garage doors 104, through its interface with the multiple sensor units.

In some embodiments, the user interface 116 is configured to provide a selectable option, receive a selection, and produce an output on the display screen 120 based on the selection. This selection may include, but is not limited to pre-assigned messages to other users, the user may input their own message to be displayed to other users, or the user may modify the parameters upon which the control unit 110 will instruct the power distribution and relay control unit 110 to operate the garage door motor 112.

In some embodiments the user interface 116 further comprises a timer; and circuitry configured to interpret time data from the timer and send one or more instructions to the control unit 110. The one or more instructions may be, but are not limited to, instructions to open or close the one or more garage doors 104 at a specific time, or to ensure that the one or more garage doors 104 are closed and remain closed after a certain time.

In some embodiments the system further comprises: a sound detector coupled to the user interface 116 unit; and circuitry configured for interpreting sound data detected by the sound detector. The sound detector may be coupled to the control unit 110, or may be located inside of the control unit 110. The sound detector data may include audio commands provided by one or more users.

In some embodiments, the user interface 116 further comprises circuitry configured for communicating wirelessly with one or more mobile devices. This circuitry may allow a user of the user interface 116 to provide messages or other information to one or more other users through the garage door control unit 110. The information may be in the form of textual notices, sound or visual notifications, or other means of alerting one or more users.

In some embodiments, the user interface 116 further comprises circuitry configured for creating a recording of changes in the position of the one or more garage doors 104 and storing the recording of changes in the position of the one or more garage doors 104 electronically. The record may include, but is not limited to, the date and time of the opening or closing of a garage door 104, which one or more users provided the command to open, which device or means was used to provide the instruction to open, and/or where the expected users were located at the time of the opening. In some embodiments, the user interface 116 is configured to use the second wireless communication interface to upload the data to a cloud server, one or more user devices, an on-site server, or other storage medium.

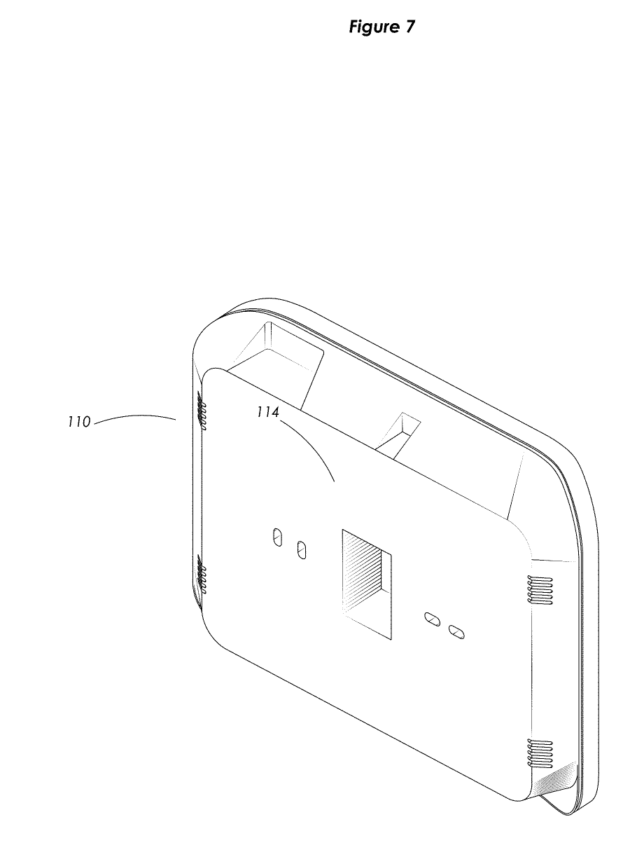

FIG. 7 is an isometric perspective of a control unit in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface unit locatable in place of the existing garage door button, wherein the user interface is configured to receive power from the power distribution and control relay unit 114 via wires repurposed from control signal wires of the existing garage door button, the user interface including: a second wireless communication interface operable to communicate wirelessly with the first wireless communication interface of the control unit 110 to enable control of the enhanced functionality; and a display screen.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door 104; one or more sensor devices 102, that detect a position of the garage door 104 from a floor indirectly using a distance from the one or more sensor devices 102 and the garage door 104 down a horizontal guidance track 108, the one or more sensor devices 102 configured to be mounted at a far end of the horizontal guidance track 108 of the garage door 104, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface unit including a display screen; a second wireless communication interface operable to communicate wirelessly with the first wireless communication interface of the one or more sensor devices 102; and a computer processor, which interprets one or more inputs from the user interface unit and data from the one or more sensor devices 102 and controls the garage door motor 112 by sending a communication to the one or more sensor devices 102 which then commands the power distribution and control relay unit 114 to operate the garage door motor 112.

In some embodiments, a system includes a control unit 110 that is locatable in place of an existing garage door button control, wherein the control unit 110 is configured to receive power from the power distribution and control relay unit 114 via control signal wires of the existing garage door button, the control unit 110 including at least: a user interface unit including a display screen; a second wireless communication interface operable to communicate wirelessly with the first wireless communication interface of the one or more sensor devices 102; and a computer processor, which interprets one or more inputs from the user interface unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 has dimensions ranging from 1 inch wide×1 inch tall×1 inch deep to 18 inches wide×18 inches tall×18 inches deep depending on the needs and configuration of the embodiment. In some embodiments the control unit 110 is characterized by a square polyhedron shape, but it can be characterized as other polyhedrons with four or more sides.

In some embodiments, the control unit 110 has a user interface including a display screen. In some embodiments, the user interface may be characterized by a variety of different variants including, but not limited to, a touchscreen, a digital display screen, an analog display screen one or more buttons, one or more dials, or a combination of the foregoing or other variants. The user interface may vary in size between be 1 inch wide×1 inch tall and 18 inches wide×18 inches tall.

In some embodiments, the control unit 110 comprises a second wireless communication interface operable to communicate wirelessly with the first wireless communication interface of the one or more sensor devices 102, and any other communication interfaces as needed. The second wireless communication interface may be entirely contained within the control unit 110 or it may have external antennae or other components beyond a housing. In some embodiments the second wireless communication interface may be configured to communicate with a home or business local area network through a direct wire connection or wirelessly. In some embodiments the second wireless communication interface receives data from a home or business local area network, while in others it receives it directly from a user's device.

In some embodiments the control unit 110 is further comprised of a computer processor which interprets one or more inputs from the user interface unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 further comprises circuitry configured for receiving data about the current, past, or possible future location of a user from one or more wireless user devices such as a smart phone, GPS device, or other location-tracking device. This data can be received through the first wireless device through communication with an internal network or directly from another device. In some embodiments the control unit 110 is further comprised of circuitry configured to instruct the power distribution and control relay unit 114 to open or close a garage door 104 based on user location data provided by one or more wireless user devices, depending on a variety of parameters set into the control unit 110's computer processor. Such parameters include, but are not limited to, a geographic region that when entered or exited triggers opening or closing of the garage door 104 respectively, reaching a certain point on a pre-programmed route triggers opening or closing of the garage door 104 respectively, time of day, day of the week, month of the year, and the year.

In some embodiments, the control unit 110 further comprises circuitry for interfacing with one or more voice control devices, such as, but not limited to, Amazon's Alexa or Apple's Siri. In some embodiments, the control unit 110 further comprises circuitry for interfacing with one or more voice control devices that may be integrated and/or to the control unit 110 itself and provide commands to the power distribution and control relay unit 114 based on words spoken by a user to the voice control device.

In some embodiments the control unit 110 further comprises circuitry configured to transmit data on the position of the garage door 104 to one or more users. In some embodiments, this circuitry is able to send the data using the second wireless communication interface to a home or business local area network, while in other embodiments the circuitry is able to instruct the second wireless communication interface to send the data on the position of one or more garage doors 104 directly to one or more user device such as a smartphone or handheld device.

In some embodiments the control unit 110 further comprises circuitry configured to notify one or more users when the garage door 104 is opened. The control unit 110's circuitry may send an alert to an application specifically designed to interface with the second wireless communication interface, or may a message such as, but not limited to, a text or other form of message may be sent to one or more users to alert them of the opening or closing of one or more garage doors 104.

In some embodiments the control unit 110 further comprises circuitry configured to allow one or more users to provide one or more commands to the control unit 110 remotely through one or more devices. The commands may include the command to open or close one or more garage doors 104, modifying settings or parameters used by the control unit 110 or its computer processor such as, but not limited to, specifying a time for one or more garage doors 104 to open, having the display screen display a message to one or more users, or modifying the range at which the garage door 104 will open for an approaching user.

In some embodiments, the control unit 110 is configured to use the second wireless communications interface to interface with additional sensor devices beyond the first and to control additional garage door motors 112 coupled to the two or more sensor devices. A singular control unit 110 can in turn control numerous garage door motors 112, and enable users to control all of the garage doors 104, through its interface with the multiple sensor units.

In some embodiments, the user interface is configured to provide a selectable option, receive a selection, and produce an output on the display screen based on the selection. This selection may include, but is not limited to pre-assigned messages to other users, the user may input their own message to be displayed to other users, or the user may modify the parameters upon which the control unit 110 will instruct the power distribution and relay control unit 110 to operate the garage door motor 112.

In some embodiments the user interface further comprises a timer; and circuitry configured to interpret time data from the timer and send one or more instructions to the control unit 110. The one or more instructions may be, but are not limited to, instructions to open or close the one or more garage doors 104 at a specific time, or to ensure that the one or more garage doors 104 are closed and remain closed after a certain time.

In some embodiments the system further comprises: a sound detector coupled to the user interface unit; and circuitry configured for interpreting sound data detected by the sound detector. The sound detector may be coupled to the control unit 110, or may be located inside of the control unit 110. The sound detector data may include audio commands provided by one or more users.

In some embodiments, the user interface further comprises circuitry configured for communicating wirelessly with one or more mobile devices. This circuitry may allow a user of the user interface to provide messages or other information to one or more other users through the garage door control unit 110. The information may be in the form of textual notices, sound or visual notifications, or other means of alerting one or more users.

In some embodiments, the user interface further comprises circuitry configured for creating a recording of changes in the position of the one or more garage doors 104 and storing the recording of changes in the position of the one or more garage doors 104 electronically. The record may include, but is not limited to, the date and time of the opening or closing of a garage door 104, which one or more users provided the command to open, which device or means was used to provide the instruction to open, and/or where the expected users were located at the time of the opening. In some embodiments, the user interface is configured to use the second wireless communication interface to upload the data to a cloud server, one or more user devices, an on-site server, or other storage medium.

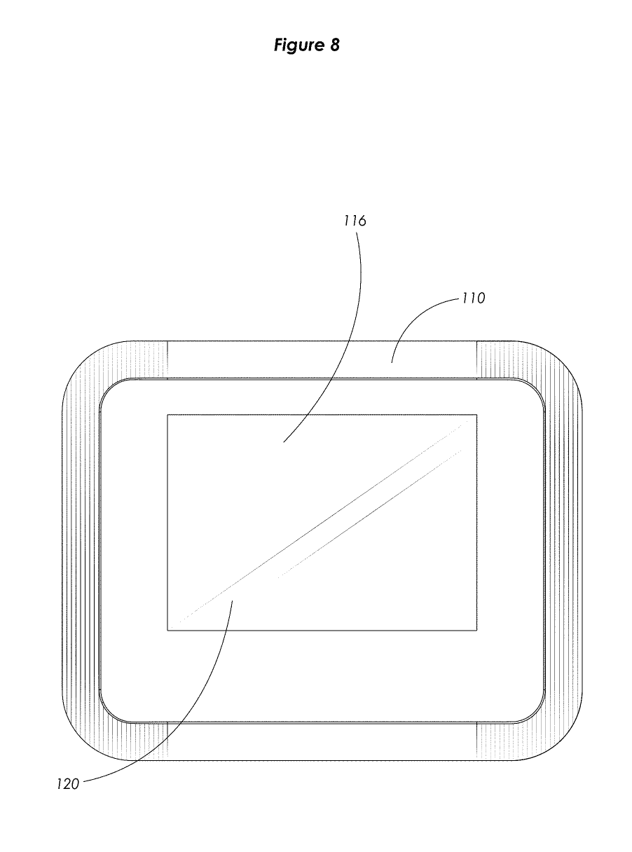

FIG. 8 is a front perspective of a control unit in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door 104; one or more sensor devices 102, that detect a position of the garage door 104 from a floor indirectly using a distance from the one or more sensor devices 102 and the garage door 104 down a horizontal guidance track 108, the one or more sensor devices 102 configured to be mounted at a far end of the horizontal guidance track 108 of the garage door 104, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, a system includes a control unit 110 that is locatable in place of an existing garage door button control, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 has dimensions ranging from 1 inch wide×1 inch tall×1 inch deep to 18 inches wide×18 inches tall×18 inches deep depending on the needs and configuration of the embodiment. In some embodiments the control unit 110 is characterized by a square polyhedron shape, but it can be characterized as other polyhedrons with four or more sides.

In some embodiments, the control unit 110 has a user interface 116 including a display screen 120. In some embodiments, the user interface 116 may be characterized by a variety of different variants including, but not limited to, a touchscreen, a digital display screen 120, an analog display screen 120 one or more buttons, one or more dials, or a combination of the foregoing or other variants. The user interface 116 may vary in size between be 1 inch wide×1 inch tall and 18 inches wide×18 inches tall.

In some embodiments, the control unit 110 comprises a second wireless communication interface operable to communicate wirelessly with the first wireless communication interface of the one or more sensor devices 102, and any other communication interfaces as needed. The second wireless communication interface may be entirely contained within the control unit 110 or it may have external antennae or other components beyond a housing. In some embodiments the second wireless communication interface may be configured to communicate with a home or business local area network through a direct wire connection or wirelessly. In some embodiments the second wireless communication interface receives data from a home or business local area network, while in others it receives it directly from a user's device.

In some embodiments the control unit 110 is further comprised of a computer processor which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 further comprises circuitry configured for receiving data about the current, past, or possible future location of a user from one or more wireless user devices such as a smart phone, GPS device, or other location-tracking device. This data can be received through the first wireless device through communication with an internal network or directly from another device. In some embodiments the control unit 110 is further comprised of circuitry configured to instruct the power distribution and control relay unit 114 to open or close a garage door 104 based on user location data provided by one or more wireless user devices, depending on a variety of parameters set into the control unit 110's computer processor. Such parameters include, but are not limited to, a geographic region that when entered or exited triggers opening or closing of the garage door 104 respectively, reaching a certain point on a pre-programmed route triggers opening or closing of the garage door 104 respectively, time of day, day of the week, month of the year, and the year.

In some embodiments, the control unit 110 further comprises circuitry for interfacing with one or more voice control devices, such as, but not limited to, Amazon's Alexa or Apple's Siri. In some embodiments, the control unit 110 further comprises circuitry for interfacing with one or more voice control devices that may be integrated and/or to the control unit 110 itself and provide commands to the power distribution and control relay unit 114 based on words spoken by a user to the voice control device.

In some embodiments the control unit 110 further comprises circuitry configured to transmit data on the position of the garage door 104 to one or more users. In some embodiments, this circuitry is able to send the data using the second wireless communication interface to a home or business local area network, while in other embodiments the circuitry is able to instruct the second wireless communication interface to send the data on the position of one or more garage doors 104 directly to one or more user device such as a smartphone or handheld device.

In some embodiments the control unit 110 further comprises circuitry configured to notify one or more users when the garage door 104 is opened. The control unit 110's circuitry may send an alert to an application specifically designed to interface with the second wireless communication interface, or may a message such as, but not limited to, a text or other form of message may be sent to one or more users to alert them of the opening or closing of one or more garage doors 104.

In some embodiments the control unit 110 further comprises circuitry configured to allow one or more users to provide one or more commands to the control unit 110 remotely through one or more devices. The commands may include the command to open or close one or more garage doors 104, modifying settings or parameters used by the control unit 110 or its computer processor such as, but not limited to, specifying a time for one or more garage doors 104 to open, having the display screen 120 display a message to one or more users, or modifying the range at which the garage door 104 will open for an approaching user.

In some embodiments, the control unit 110 is configured to use the second wireless communications interface to interface with additional sensor devices beyond the first and to control additional garage door motors 112 coupled to the two or more sensor devices. A singular control unit 110 can in turn control numerous garage door motors 112, and enable users to control all of the garage doors 104, through its interface with the multiple sensor units.

In some embodiments, the user interface 116 is configured to provide a selectable option, receive a selection, and produce an output on the display screen 120 based on the selection. This selection may include, but is not limited to pre-assigned messages to other users, the user may input their own message to be displayed to other users, or the user may modify the parameters upon which the control unit 110 will instruct the power distribution and relay control unit 110 to operate the garage door motor 112.

In some embodiments the user interface 116 further comprises a timer; and circuitry configured to interpret time data from the timer and send one or more instructions to the control unit 110. The one or more instructions may be, but are not limited to, instructions to open or close the one or more garage doors 104 at a specific time, or to ensure that the one or more garage doors 104 are closed and remain closed after a certain time.

In some embodiments the system further comprises: a sound detector coupled to the user interface 116 unit; and circuitry configured for interpreting sound data detected by the sound detector. The sound detector may be coupled to the control unit 110, or may be located inside of the control unit 110. The sound detector data may include audio commands provided by one or more users.

In some embodiments, the user interface 116 further comprises circuitry configured for communicating wirelessly with one or more mobile devices. This circuitry may allow a user of the user interface 116 to provide messages or other information to one or more other users through the garage door control unit 110. The information may be in the form of textual notices, sound or visual notifications, or other means of alerting one or more users.

In some embodiments, the user interface 116 further comprises circuitry configured for creating a recording of changes in the position of the one or more garage doors 104 and storing the recording of changes in the position of the one or more garage doors 104 electronically. The record may include, but is not limited to, the date and time of the opening or closing of a garage door 104, which one or more users provided the command to open, which device or means was used to provide the instruction to open, and/or where the expected users were located at the time of the opening. In some embodiments, the user interface 116 is configured to use the second wireless communication interface to upload the data to a cloud server, one or more user devices, an on-site server, or other storage medium.

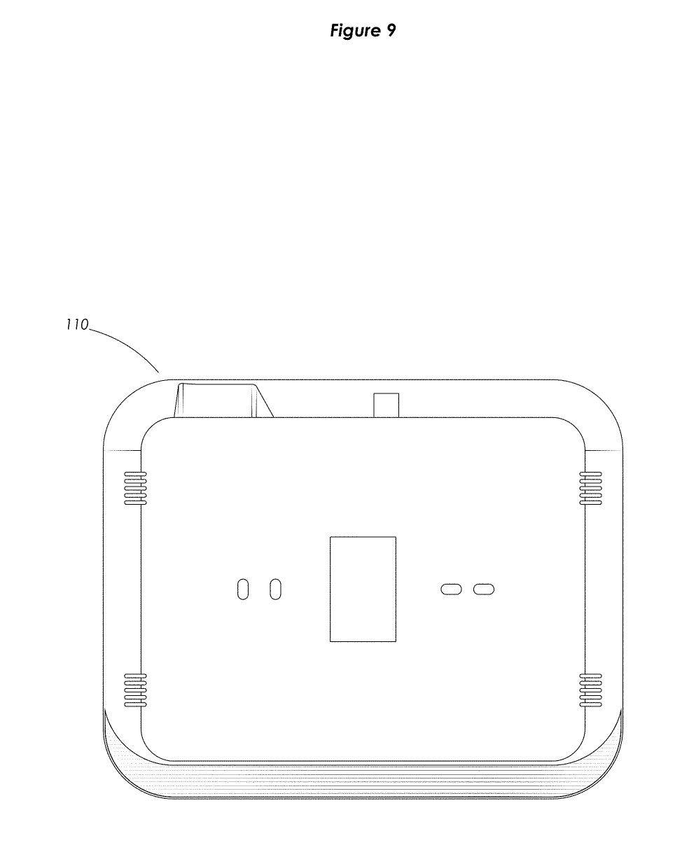

FIG. 9 is a rear perspective of a control unit in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface unit locatable in place of the existing garage door button, wherein the user interface is configured to receive power from the power distribution and control relay unit 114 via wires repurposed from control signal wires of the existing garage door button, the user interface including: a second wireless communication interface operable to communicate wirelessly with the first wireless communication interface of the control unit 110 to enable control of the enhanced functionality; and a display screen.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door 104; one or more sensor devices 102, that detect a position of the garage door 104 from a floor indirectly using a distance from the one or more sensor devices 102 and the garage door 104 down a horizontal guidance track 108, the one or more sensor devices 102 configured to be mounted at a far end of the horizontal guidance track 108 of the garage door 104, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface unit including a display screen; a second wireless communication interface operable to communicate wirelessly with the first wireless communication interface of the one or more sensor devices 102; and a computer processor, which interprets one or more inputs from the user interface unit and data from the one or more sensor devices 102 and controls the garage door motor 112 by sending a communication to the one or more sensor devices 102 which then commands the power distribution and control relay unit 114 to operate the garage door motor 112.

In some embodiments, a system includes a control unit 110 that is locatable in place of an existing garage door button control, wherein the control unit 110 is configured to receive power from the power distribution and control relay unit 114 via control signal wires of the existing garage door button, the control unit 110 including at least: a user interface unit including a display screen; a second wireless communication interface operable to communicate wirelessly with the first wireless communication interface of the one or more sensor devices 102; and a computer processor, which interprets one or more inputs from the user interface unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 has dimensions ranging from 1 inch wide×1 inch tall×1 inch deep to 18 inches wide×18 inches tall×18 inches deep depending on the needs and configuration of the embodiment. In some embodiments the control unit 110 is characterized by a square polyhedron shape, but it can be characterized as other polyhedrons with four or more sides.

In some embodiments, the control unit 110 has a user interface including a display screen. In some embodiments, the user interface may be characterized by a variety of different variants including, but not limited to, a touchscreen, a digital display screen, an analog display screen one or more buttons, one or more dials, or a combination of the foregoing or other variants. The user interface may vary in size between be 1 inch wide×1 inch tall and 18 inches wide×18 inches tall.

In some embodiments, the control unit 110 comprises a second wireless communication interface operable to communicate wirelessly with the first wireless communication interface of the one or more sensor devices 102, and any other communication interfaces as needed. The second wireless communication interface may be entirely contained within the control unit 110 or it may have external antennae or other components beyond a housing. In some embodiments the second wireless communication interface may be configured to communicate with a home or business local area network through a direct wire connection or wirelessly. In some embodiments the second wireless communication interface receives data from a home or business local area network, while in others it receives it directly from a user's device.

In some embodiments the control unit 110 is further comprised of a computer processor which interprets one or more inputs from the user interface unit and data from the one or more sensor devices 102 and controls the garage door motor 112 by sending a communication to the one or more sensor devices 102 which then commands the power distribution and control relay unit 114 to operate the garage door motor 112.

In some embodiments, the control unit 110 further comprises circuitry configured for receiving data about the current, past, or possible future location of a user from one or more wireless user devices such as a smart phone, GPS device, or other location-tracking device. This data can be received through the first wireless device through communication with an internal network or directly from another device. In some embodiments the control unit 110 is further comprised of circuitry configured to instruct the power distribution and control relay unit 114 to open or close a garage door 104 based on user location data provided by one or more wireless user devices, depending on a variety of parameters set into the control unit 110's computer processor. Such parameters include, but are not limited to, a geographic region that when entered or exited triggers opening or closing of the garage door 104 respectively, reaching a certain point on a pre-programmed route triggers opening or closing of the garage door 104 respectively, time of day, day of the week, month of the year, and the year.

In some embodiments, the control unit 110 further comprises circuitry for interfacing with one or more voice control devices, such as, but not limited to, Amazon's Alexa or Apple's Siri. In some embodiments, the control unit 110 further comprises circuitry for interfacing with one or more voice control devices that may be integrated and/or to the control unit 110 itself and provide commands to the power distribution and control relay unit 114 based on words spoken by a user to the voice control device.

In some embodiments the control unit 110 further comprises circuitry configured to transmit data on the position of the garage door 104 to one or more users. In some embodiments, this circuitry is able to send the data using the second wireless communication interface to a home or business local area network, while in other embodiments the circuitry is able to instruct the second wireless communication interface to send the data on the position of one or more garage doors 104 directly to one or more user device such as a smartphone or handheld device.

In some embodiments the control unit 110 further comprises circuitry configured to notify one or more users when the garage door 104 is opened. The control unit 110's circuitry may send an alert to an application specifically designed to interface with the second wireless communication interface, or may a message such as, but not limited to, a text or other form of message may be sent to one or more users to alert them of the opening or closing of one or more garage doors 104.

In some embodiments the control unit 110 further comprises circuitry configured to allow one or more users to provide one or more commands to the control unit 110 remotely through one or more devices. The commands may include the command to open or close one or more garage doors 104, modifying settings or parameters used by the control unit 110 or its computer processor such as, but not limited to, specifying a time for one or more garage doors 104 to open, having the display screen display a message to one or more users, or modifying the range at which the garage door 104 will open for an approaching user.

In some embodiments, the control unit 110 is configured to use the second wireless communications interface to interface with additional sensor devices beyond the first and to control additional garage door motors 112 coupled to the two or more sensor devices. A singular control unit 110 can in turn control numerous garage door motors 112, and enable users to control all of the garage doors 104, through its interface with the multiple sensor units.

In some embodiments, the user interface is configured to provide a selectable option, receive a selection, and produce an output on the display screen based on the selection. This selection may include, but is not limited to pre-assigned messages to other users, the user may input their own message to be displayed to other users, or the user may modify the parameters upon which the control unit 110 will instruct the power distribution and relay control unit 110 to operate the garage door motor 112.

In some embodiments the user interface further comprises a timer; and circuitry configured to interpret time data from the timer and send one or more instructions to the control unit 110. The one or more instructions may be, but are not limited to, instructions to open or close the one or more garage doors 104 at a specific time, or to ensure that the one or more garage doors 104 are closed and remain closed after a certain time.

In some embodiments the system further comprises: a sound detector coupled to the user interface unit; and circuitry configured for interpreting sound data detected by the sound detector. The sound detector may be coupled to the control unit 110, or may be located inside of the control unit 110. The sound detector data may include audio commands provided by one or more users.

In some embodiments, the user interface further comprises circuitry configured for communicating wirelessly with one or more mobile devices. This circuitry may allow a user of the user interface to provide messages or other information to one or more other users through the garage door control unit 110. The information may be in the form of textual notices, sound or visual notifications, or other means of alerting one or more users.

In some embodiments, the user interface further comprises circuitry configured for creating a recording of changes in the position of the one or more garage doors 104 and storing the recording of changes in the position of the one or more garage doors 104 electronically. The record may include, but is not limited to, the date and time of the opening or closing of a garage door 104, which one or more users provided the command to open, which device or means was used to provide the instruction to open, and/or where the expected users were located at the time of the opening. In some embodiments, the user interface is configured to use the second wireless communication interface to upload the data to a cloud server, one or more user devices, an on-site server, or other storage medium.

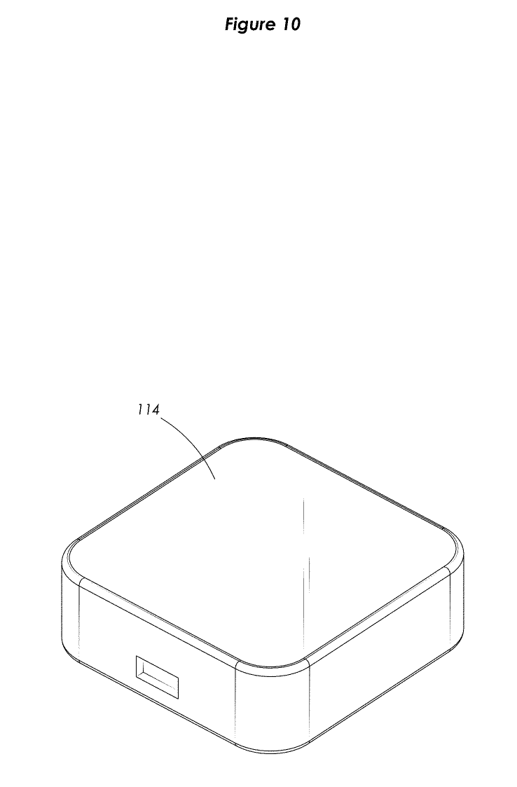

FIG. 10 is an isometric perspective of a power distribution and control relay unit in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door; one or more sensor devices 102, that detect a position of the garage door from a floor indirectly using a distance from the one or more sensor devices 102 and the garage door down a horizontal guidance track 108, the one or more sensor devices 102 configured to be mounted at a far end of the horizontal guidance track 108 of the garage door, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the power distribution and control relay unit 114 ranges in dimensions from 1 inch×1 inch×1 inch to 10 inches×10 inches×10 inches. The power distribution and control relay unit 114 may have one or more external ports through which it may connect to or be connected to sources of power or other wires. The power distribution and control relay unit 114 may have an integrated DC or AC wire connector, and ports to connect an existing garage door control wire. The power distribution and control relay unit 114 may have a mechanism to attach to a garage door motor 112 or other surface which may be characterized as, but not limited to, a magnetized strip, adhesives, a latch, a locking mechanism, an integrated screw or screws, channels for other fasteners, or some combination of the aforementioned or other fastening mechanisms.

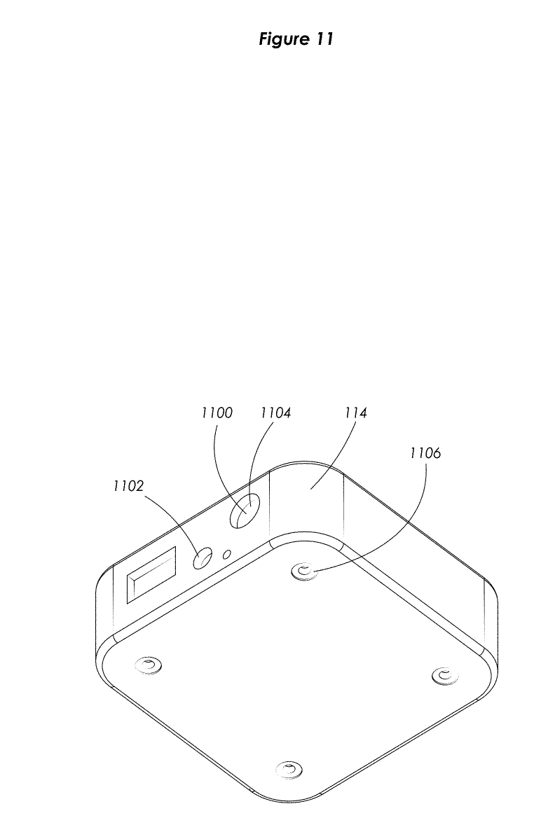

FIG. 11 is an isometric perspective of a power distribution and control relay unit in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door; one or more sensor devices 102, that detect a position of the garage door from a floor indirectly using a distance from the one or more sensor devices 102 and the garage door down a horizontal guidance track 108, the one or more sensor devices 102 configured to be mounted at a far end of the horizontal guidance track 108 of the garage door, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the power distribution and control relay unit 114 ranges in dimensions from 1 inch×1 inch×1 inch to 10 inches×10 inches×10 inches. The power distribution and control relay unit 114 may have one or more external ports 1100 through which it may connect to or be connected to sources of power or other wires. The power distribution and control relay unit 114 may have an integrated DC or AC wire connector 1102, and ports to connect an existing garage door control wire 1104. The power distribution and control relay unit 114 may have a mechanism 1106 to attach to a garage door motor 112 or other surface which may be characterized as, but not limited to, a magnetized strip, adhesives, a latch, a locking mechanism, an integrated screw or screws, channels for other fasteners, or some combination of the aforementioned or other fastening mechanisms.

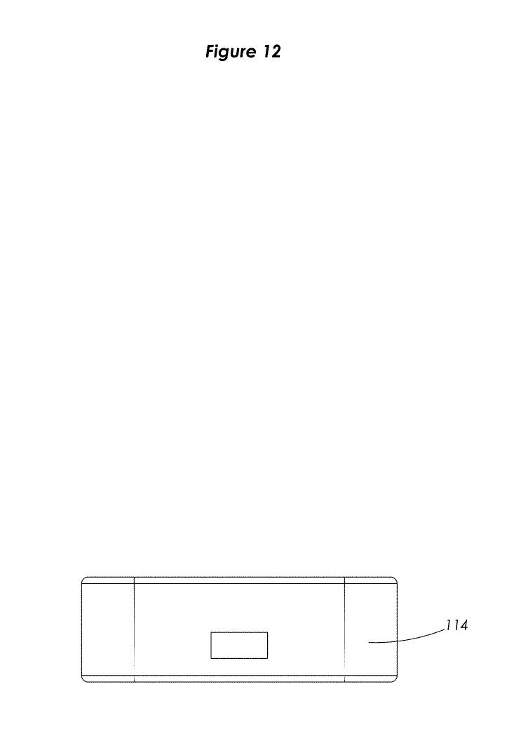

FIG. 12 is a front perspective of a power distribution and control relay unit in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door; one or more sensor devices 102, that detect a position of the garage door from a floor indirectly using a distance from the one or more sensor devices 102 and the garage door down a horizontal guidance track 108, the one or more sensor devices 102 configured to be mounted at a far end of the horizontal guidance track 108 of the garage door, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the power distribution and control relay unit 114 ranges in dimensions from 1 inch×1 inch×1 inch to 10 inches×10 inches×10 inches. The power distribution and control relay unit 114 may have one or more external ports through which it may connect to or be connected to sources of power or other wires. The power distribution and control relay unit 114 may have an integrated DC or AC wire connector, and ports to connect an existing garage door control wire. The power distribution and control relay unit 114 may have a mechanism to attach to a garage door motor 112 or other surface which may be characterized as, but not limited to, a magnetized strip, adhesives, a latch, a locking mechanism, an integrated screw or screws, channels for other fasteners, or some combination of the aforementioned or other fastening mechanisms.

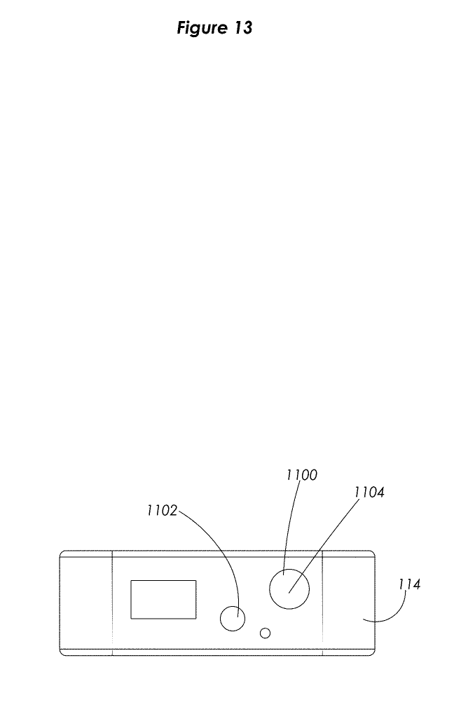

FIG. 13 is a rear perspective of a power distribution and control relay unit in accordance with an embodiment of the invention.

In one embodiment, a system is comprised of: one or more sensor devices 102 that are configured to detect a position of a garage door from a floor indirectly using a distance from the one or more sensor devices 102 and the garage door down a horizontal guidance track 108, the one or more sensor devices 102 configured to be mounted at a far end of the horizontal guidance track 108 of the garage door, the one or more sensor devices 102 including: one or more emitters, one or more detectors; a control unit 110 configured to be mounted proximate a garage door motor 112 for the garage door and coupled to the one or more sensor devices 102, the control unit 110 including at least: a computer processor configured to provide the enhanced functionality; a power distribution and control relay unit 114; a first wireless communication interface operable to communicate wirelessly; and a link operable to be connected to the garage door motor 112; and a user interface 116 unit locatable in place of the existing garage door button, wherein the user interface 116 is configured to receive power from the power distribution and control relay unit 114 via wires repurposed from control signal wires of the existing garage door button, the user interface 116 including: a second wireless communication interface operable to communicate wirelessly with the first wireless communication interface of the control unit 110 to enable control of the enhanced functionality; and a display screen 120.

In one embodiment, a system is comprised of: a power distribution and control relay unit 114, wherein the power distribution and control relay unit 114 is configured to receive power from an existing wall plug and distribute the power, and wherein the power distribution and control relay unit 114 is configured to be linked to a garage door motor 112 for a garage door; one or more sensor devices 102, that detect a position of the garage door from a floor indirectly using a distance from the one or more sensor devices 102 and the garage door down a horizontal guidance track 108, the one or more sensor devices 102 configured to be mounted at a far end of the horizontal guidance track 108 of the garage door, wherein the one or more sensor devices 102 receive power from the power distribution and control relay unit 114 and are configured to send commands to the power distribution and control relay unit 114, the one or more sensor devices 102 including: one or more emitters, one or more detectors, and a first wireless communication interface operable to communicate wirelessly; and a control unit 110, locatable in place of the existing garage door button, wherein the control unit 110 is configured to receive power from the power distribution and control relay unit 114 via control signal wires of the existing garage door button, the control unit 110 including at least: a user interface 116 unit including a display screen 120; a second wireless communication interface operable to communicate wirelessly with the first wireless communication interface of the one or more sensor devices 102; and a computer processor, which interprets one or more inputs from the user interface 116 unit and data from the one or more sensor devices 102 and controls the garage door motor 112 by sending a communication to the one or more sensor devices 102 which then commands the power distribution and control relay unit 114 to operate the garage door motor 112.

In some embodiments, the power distribution and control relay unit 114 ranges in dimensions from 1 inch×1 inch×1 inch to 10 inches×10 inches×10 inches. The power distribution and control relay unit 114 may have one or more external ports 1100 through which it may connect to or be connected to sources of power or other wires. The power distribution and control relay unit 114 may have an integrated DC or AC wire connector 1102, and ports to connect an existing garage door control wire 1104. The power distribution and control relay unit 114 may have a mechanism 1106 to attach to a garage door motor 112 or other surface which may be characterized as, but not limited to, a magnetized strip, adhesives, a latch, a locking mechanism, an integrated screw or screws, channels for other fasteners, or some combination of the aforementioned or other fastening mechanisms.

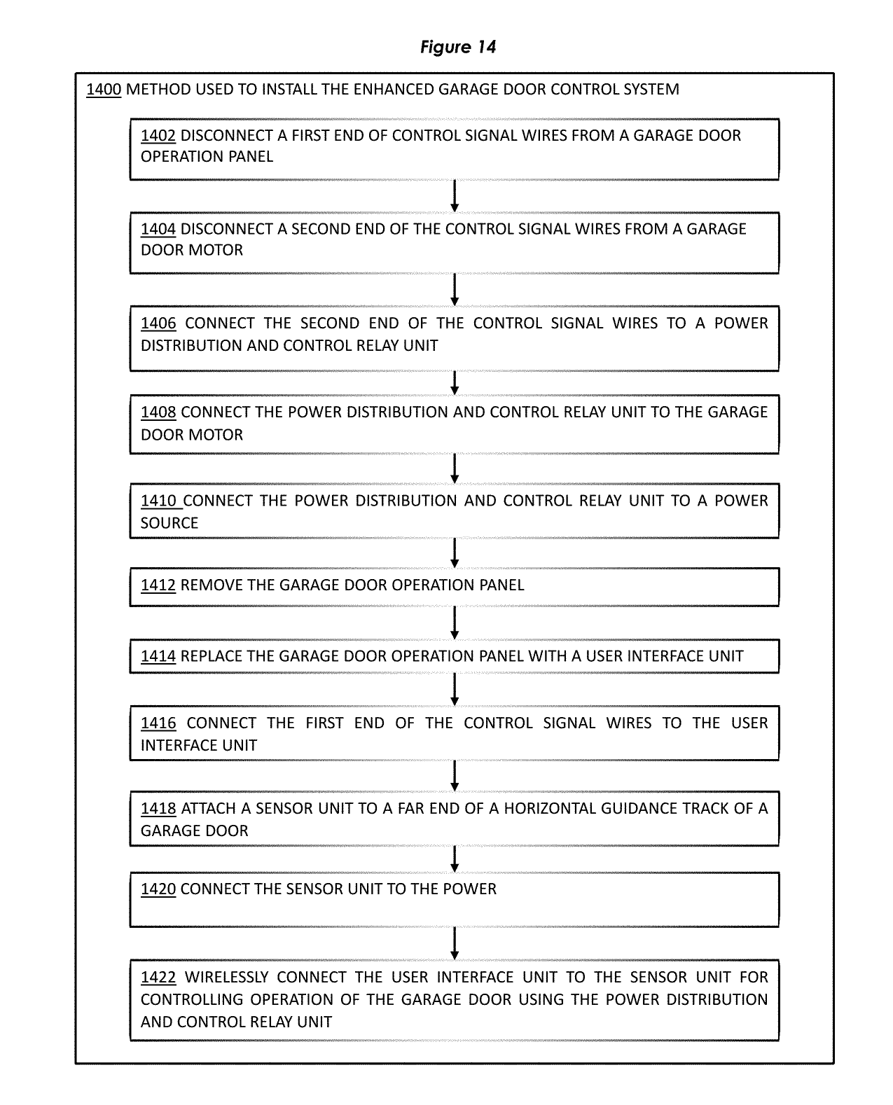

FIG. 14 is a block diagram of the method used to install the enhanced garage door control system, in accordance with an embodiment of the invention. In one embodiment, the method 1400 begins by disconnecting a first end of control signal wires from a garage door operation panel 1402; disconnecting a second end of the control signal wires from a garage door motor 1404; connecting the second end of the control signal wires to a power distribution and control relay unit 1406; connecting the power distribution and control relay unit to the garage door motor 1408; connecting the power distribution and control relay unit to a power source 1410; removing the garage door operation panel 1412; replacing the garage door operation panel with a user interface unit 1414; connecting the first end of the control signal wires to the user interface unit 1416; attaching a sensor unit to a far end of a horizontal guidance track of a garage door 1418; connecting the sensor unit to the power distribution and control relay unit 1420; wirelessly connecting the user interface unit to the sensor unit for controlling operation of the garage door using the power distribution and control relay unit 1422.

In some embodiments the exact order of the process can be modified or reversed. In some embodiments, certain steps such as removing the garage door operation panel, may be unnecessary due to the design of the existing garage door operation panel.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A system that replaces an existing garage door button to provide enhanced functionality without requiring rewiring, the system comprising:
one or more sensor devices that are configured to detect a position of a garage door from a floor indirectly using a distance from the one or more sensor devices and the garage door down a horizontal guidance track, the one or more sensor devices configured to be mounted at a far end of the horizontal guidance track of the garage door, the one or more sensor devices including:
one or more emitters,
one or more detectors;
a control unit configured to be mounted proximate a garage door motor for the garage door and coupled to the one or more sensor devices, the control unit including at least:
a computer processor configured to provide the enhanced functionality;
a power distribution and control relay unit;
a first wireless communication interface operable to communicate wirelessly; and
a link operable to be connected to the garage door motor; and
a user interface unit locatable in place of the existing garage door button, wherein the user interface is configured to receive power from the power distribution and control relay unit via wires repurposed from control signal wires of the existing garage door button, the user interface including:
a second wireless communication interface operable to communicate wirelessly with the first wireless communication interface of the control unit to enable control of the enhanced functionality; and
a display screen.

2. The system of claim 1, wherein the control unit further comprises:
circuitry configured for interfacing with one or more voice control devices.

3. The system of claim 1, wherein the control unit further comprises:
circuitry configured to transmit data on the position of the garage door to one or more users.

4. The system of claim 1, wherein the one or more emitters is an ultrasonic emitter and the one or more detectors is an ultrasonic detector.

5. The system of claim 1, wherein the one or more emitters is a laser emitter and the one or more detectors is a laser detector.

6. The system of claim 1, wherein the user interface further comprises:
circuitry configured for creating a recording of changes in the position of the one or more garage doors and storing the recording of changes in the position of the one or more garage doors electronically.

7. The system of claim 1, wherein the user interface further comprises:
a timer; and
circuitry configured to interpret time data from the timer and send one or more instructions to the control unit.

8. The system of claim 1, wherein the system further comprises:
a sound detector coupled to the user interface unit; and
circuitry configured for interpreting sound data detected by the sound detector.

9. A system that replaces an existing garage door button to provide enhanced functionality without requiring new wiring, the system comprising:
a power distribution and control relay unit, wherein the power distribution and control relay unit is configured to receive power from an existing wall plug and distribute the power, and wherein the power distribution and control relay unit is configured to be linked to a garage door motor for a garage door;
one or more sensor devices, that detect a position of the garage door from a floor indirectly using a distance from the one or more sensor devices and the garage door down a horizontal guidance track, the one or more sensor devices configured to be mounted at a far end of the horizontal guidance track of the garage door, wherein the one or more sensor devices receive power from the power distribution and control relay unit and are configured to send commands to the power distribution and control relay unit, the one or more sensor devices including:
one or more emitters,
one or more detectors, and
a first wireless communication interface operable to communicate wirelessly; and
a control unit, locatable in place of the existing garage door button, wherein the control unit is configured to receive power from the power distribution and control relay unit via control signal wires of the existing garage door button, the control unit including at least:
a user interface unit including a display screen;
a second wireless communication interface operable to communicate wirelessly with the first wireless communication interface of the one or more sensor devices; and
a computer processor, which interprets one or more inputs from the user interface unit and data from the one or more sensor devices and controls the garage door motor by sending a communication to the one or more sensor devices which then commands the power distribution and control relay unit to operate the garage door motor.

10. The system of claim 9, wherein the control unit further comprises:
circuitry configured for receiving user location data from one or more user devices.

11. The device of claim 10, wherein the control unit further comprises:
circuitry configured for opening or closing a garage door based on user location data from one or more user devices.

12. The system of claim 9, wherein the control unit further comprises:
circuitry configured to notify one or more users when the garage door is opened.

13. The system of claim 9, wherein the control unit further comprises:
circuitry configured to allow one or more users to provide one or more commands to the control unit remotely through one or more devices.

14. The system of claim 9, wherein the user interface is configured to provide a selectable option, receive a selection, and produce an output on the display screen based on the selection.

15. The system of claim 9, wherein the user interface further comprises:
circuitry configured for communicating wirelessly with one or more mobile devices.

16. The system of claim 9, wherein the control unit is configured to interface with two or more sensor devices and to control garage door motors coupled to the two or more sensor devices.

17. The system of claim 9, wherein the system further comprises:
one or more additional sensor devices including at least:
a third wireless communication interface operable to communicate wirelessly with the second wireless communication interface of the control unit to enable control of the enhanced functionality.

18. The system of claim 9, wherein the control unit is configured to provide instructions to additional sensor devices beyond the first and is configured to distinguish between the additional sensor devices.

19. The system of claim 9, wherein the control unit is configured to interpret sensor data from additional sensor units and provide instructions to control one or more additional garage door motors.

20. A method for installing an enhanced garage door control device to enable enhanced functionality, the method comprising;
disconnecting a first end of control signal wires from a garage door operation panel;
disconnecting a second end of the control signal wires from a garage door motor;
connecting the second end of the control signal wires to a power distribution and control relay unit;
connecting the power distribution and control relay unit to the garage door motor;
connecting the power distribution and control relay unit to a power source;
removing the garage door operation panel;
replacing the garage door operation panel with a user interface unit;
connecting the first end of the control signal wires to the user interface unit;
attaching a sensor unit to a far end of a horizontal guidance track of a garage door;
connecting the sensor unit to the power distribution and control relay unit;
wirelessly connecting the user interface unit to the sensor unit for controlling operation of the garage door using the power distribution and control relay unit.
